(19) United States
(12) Patent Application Publication
(10) Pub. No.: US 2014/0176055 A1
(43) Pub. Date: Jun. 26, 2014

(54) WIRELESS CHARGER

(71) Applicant: NXP B.V., Eindhoven (NL)

(72) Inventors: Johannes Petrus Maria van Lammeren, Beuningen (NL); Aliaksei Vladimirovich Sedzin, Eindhoven (NL); Klaas Brink, Waalre (NL)

(73) Assignee: NXP B. V., Eindhoven (NL)

(21) Appl. No.: 13/721,504

(22) Filed: Dec. 20, 2012

(51) Int. Cl. H04B 5/00; H01F 38/14

(52) U.S. Cl. CPC H04B 5/0037; H01F 38/14
USPC 320/108

(57) ABSTRACT

An apparatus (pad) and method for wirelessly charging a receiver are disclosed. The pad includes one or more NFC antennas which can receive an NFC signal from the receiver. The pad also contains one or more charging coils. Measurement of the signal strength at each charging NFC antenna helps determine which charging coil(s) should be utilized to effect the most efficient charging of the receiver.

### FIELD OF THE INVENTION

This invention relates to an apparatus and method for wirelessly charging a variety of equipments or devices. The apparatus and method facilitate the free or random placement of the equipment or device to be charged upon the charger.

### BACKGROUND OF THE INVENTION

Many equipments or devices, including, for example, mobile phones and electronic equipment, to name but a few, contain rechargeable batteries. An increasingly popular method of recharging such rechargeable batteries is wireless or inductive charging. An example of the use of wireless charging is provided in U.S. Pat. No. 8,212,518. It is common to refer to the charging apparatus as the “transmitter” or “charging pad” or “pad” and to the device or equipment being charged as the “receiver”. Both the receiver and the pad typically have respective coils between which the energy for charging the receiver's battery is transferred via inductive coupling.

In order to effectively charge the receiver, an adequate alignment between the coil of the receiver and the coil of the pad is necessary. Some pads employ fixed positioning in order to assure alignment between pad and receiver coils. Such alignment may be based upon the use of matching shapes or magnets in the pad and receiver.

Free-positioning pads allow the receiver to be positioned anywhere on the pad. Typically such a pad has an array of embedded charging coils. However, knowledge of the precise position of the receiver on the pad is required so that the appropriate coil(s) are energized in order to assure close inductive coupling between the pad and the receiver.

### SUMMARY OF THE INVENTION

Illustrative embodiments of the invention include a method of charging a receiver which is capable of creating an NFC field, the method including: providing a pad having a plurality of charging coils arranged in an array and a plurality of NFC antennas arranged in an array; placing the receiver upon the pad; causing the receiver to create an NFC field; measuring the NFC field strength at two or more NFC antennas in the pad; comparing the NFC field strengths at two or more NFC antennas to determine at least one NFC antenna with greater field strength; selecting one or more charging coils associated with the NFC antenna receiving the greater field strength; and activating one or more charging coils to charge the receiver.

Furthermore other illustrative embodiments may include: associating each of the charging coils with a respective concentric NFC antenna; measuring the NFC field strength and comparing the NFC field strengths throughout the charging process and possibly further, selecting a different charging coil during the charging process. Furthermore, one may illustratively have the number of charging coils equal to the number of NFC antennas and possibly activating such associated charging coil when its respective NFC antenna receives the greater or greatest field strength. One or more controllers serve to direct power to the appropriate charging coil(s); receive and interpret signals from NFC coils, including comparison of NFC inputs, and controls the performance of the other described functions.

### BRIEF DESCRIPTION OF THE DRAWINGS

FIG. 1 is a partially exposed plan view of an illustrative embodiment of the invention;

FIG. 2 is a portion of a partially exposed plan view of an alternative embodiment of the invention;

FIG. 3 is a schematic view of an alternative embodiment of the invention.

### DETAILED DESCRIPTION OF EXEMPLARY EMBODIMENTS

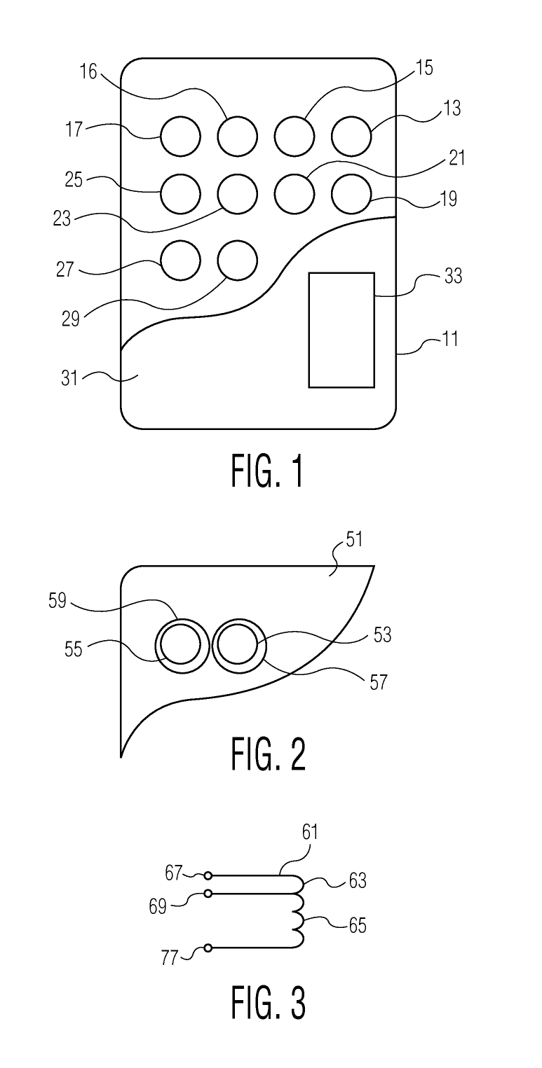

In FIG. 1, reference numeral 11 denotes a charging pad. Reference numerals 15, 16, 17, 19, 21, 23, 25, 27, and 29 denote Near Field Communication (NFC) coils. A greater or lesser number of NFC coils may be used. A receiver (not shown) is presumed to also have NFC functionality, i.e. to have an NFC antenna and be capable of sending an NFC signal via such antenna. NFC typically involves transmission centered at 13.56 MHz and provides for information transfer over comparatively short distances, typically 10 cm or so.

A variety of standards relate to NFC, including standards defined by the NFC Forum, and ISO/IEC, ECMA, ETSI/SCP (Smart Card Platform), GlobalPlatform and EMVCo, ECMA-340, ECMA-352, ISO/IEC 14443 (Type A and B), ISO 15693, ISO/IEC 18092 and ISO/IEC 21481, NFC Data Exchange Format (NDEF), Simple NDEF Exchange Protocol, and FeliCa.

Pad 11 also contains a plurality of spaced-apart charging coils suitable for charging the battery of the receiver.

In operation, the receiver is placed upon upper surface 31 of pad 11. The receiver transmits an NFC signal. The NFC signal is received by the NFC coils, 15, 16, 17, 19, 21, 23, 25, 27, and 29. But the signal strength at each of the NFC coils depends upon the relative distance of the coil from the NFC antenna in the receiver. Consequently, it is possible to measure the signal strength at each of the NFC coils and thereby determine at least the approximate location of the receiver on the pad. Illustratively, if the received signal strength is strongest at coil 23, one may presume that the receiver is proximate to NFC coil 23. Consequently whatever charging coil or coils are nearest NFC coil 23 can be turned on to charge the receiver.

An alternative embodiment is disclosed in FIG. 2. Reference numeral 51 denotes a portion of a pad. Reference numerals 53 and 55 denote NFC coils. NFC coils 53 and 55 are placed within and more or less concentrically with respective charging coils 57 and 59. If for example, the received signal strength is greatest at NFC coil 53, then charging coil 57 may be turned on. Other charging coils in the vicinity of NFC coil 53, for example, charging coil 59 may also be turned on, depending on the charging procedure, etc.

In another embodiment, the charging coils and the NFC coils may be the same coil, e.g. a few windings of each charging coil are also used for NFC reception. Such embodiment is illustrated in FIG. 3. In FIG. 3, coil 61 has taps 67, 69, and 71. Illustratively, coil segment 63 may be used to receive an NFC signal at taps 67 and 69. During the charging operation, taps 67 and 71 may be energized, thereby engaging the entire coil, namely segments 63 and 65.

Furthermore, the detection procedure described above may be performed sporadically during charging to determine whether the receiver has moved. For example, if the receiver has been bumped or knocked aside, a re-performance of the detection procedure and subsequent choice of new charging coil(s) will help insure better charging efficiency and shorter charging time. The re-performance of the position detection can also be initiated if e.g. the receiver detects a sudden change of the received power.

Operation of pad 11 is achieved through one or more controllers 33 which direct power to appropriate charging coil(s); receive and interpret signals from NFC coils, including comparison of NFC inputs; and control the performance of the other described functions.

Various exemplary embodiments are described in reference to specific illustrative examples. The illustrative examples are selected to assist a person of ordinary skill in the art to form a clear understanding of, and to practice the various embodiments. However, the scope of systems, structures and devices that may be constructed to have one or more of the embodiments, and the scope of methods that may be implemented according to one or more of the embodiments, are in no way confined to the specific illustrative examples that have been presented. On the contrary, as will be readily recognized by persons of ordinary skill in the relevant arts based on this description, many other configurations, arrangements, and methods according to the various embodiments may be implemented.

To the extent positional designations such as top, bottom, upper, lower have been used in describing this invention, it will be appreciated that those designations are given with reference to the corresponding drawings, and that if the orientation of the device changes during manufacturing or operation, other positional relationships may apply instead. As described above, those positional relationships are described for clarity, not limitation.

The present invention has been described with respect to particular embodiments and with reference to certain drawings, but the invention is not limited thereto, but rather, is set forth only by the claims. The drawings described are only schematic and are non-limiting. In the drawings, for illustrative purposes, the size of various elements may be exaggerated and not drawn to a particular scale. It is intended that this invention encompasses inconsequential variations in the relevant tolerances and properties of components and modes of operation thereof. Imperfect practice of the invention is intended to be covered.

Where the term “comprising” is used in the present description and claims, it does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. This expression signifies that, with respect to the present invention, the only relevant components of the device are A and B.

What is claimed is:

1. A method for charging a receiver capable of creating an NFC field comprising:
providing a pad having a plurality of charging coils arranged in an array and a plurality of NFC antennas arranged in an array;
placing said receiver upon said pad;
causing said receiver to create an NFC field;
measuring said NFC field strength at two or more NFC antennas in said pad;
comparing said NFC field strengths at said two or more NFC antennas to determine at least one NFC antenna with greater field strength;
selecting one or more charging coils associated with said at least one NFC antenna according to a predetermined rule;
activating said one or more charging coils to charge said receiver.

2. The method of claim 1 in which each of said charging coils has an associated concentric NFC antenna.

3. The method of claim 1 in which the steps of measuring said NFC field strength and comparing said NFC field strength is performed throughout the charging process.

4. The method of claim 3 further including selecting at least one different charging coil and activating said at least one different charging coil during the charging process.

5. The method of claim 1 in which the number of charging coils is equal to the number of NFC antennas.

6. The method of claim 1 in which the number of charging coils is equal to the number of NFC antennas and said predetermined rule associates one charging coil with an unique NFC antenna and prescribes the activation of said associated one charging coil if said unique NFC antenna has receives greatest field strength.

7. The method of claim 1 in which each or a part of each charging coil is also an NFC antenna.

8. A charging pad comprising: a plurality of charging coils arranged in an array and a plurality of NFC antennas arranged in an array; each of said charging coils being associated with a respective said NFC antenna and being capable of being activated to charge a receiver after measurement of field strength at its respective NFC antenna.

9. A charging pad comprising a plurality of charging coils, each said coil having first, second, and third taps; said first and second taps being located to permit the reception of an NFC signal; and said first and third taps connecting to the ends of said coil for providing charging energy.

10. The device of claim 8 further including a controller for receiving said measurement of field strength and selecting one or more, but less than all, of said charging coils to perform charging.

11. The device of claim 9 further including a controller for receiving said NFC signal and determining at which coil(s) said NFC signal is strongest and for causing said coil(s) to commence providing charging energy.
